(19) United States
(12) Patent Application Publication
(10) Pub. No.: US 2004/0208961 A1
(43) Pub. Date: Oct. 21, 2004

(54) Fast-food sandwich preparation kitchen arrangement

(76) Inventors: John Reckert, Cooper City, FL (US); Myong J. Lee, Elk River, MN (US); Mark Finch, Lea Davie, FL (US); Duane Crisp, Columbia City, IN (US)

Correspondence Address: FROMMER LAWRENCE & HAUG LLP, 745 FIFTH AVENUE, NEW YORK, NY, 10151, US

(21) Appl. No.: 10/413,686

(22) Filed: Apr. 15, 2003

(51) Int. Cl. A23G 1/00

(52) U.S. Cl. 426/275

(57) ABSTRACT

The food preparation kitchen of the present invention provides an arrangement and method of use of kitchen equipment to facilitate a combination of batch preparation and made-to-order assembly of fast-food sandwiches. This food preparation kitchen includes a broiling member for broiling frozen sandwich products; a first product holding member for holding sandwich products from the broiling means; a receiving container for holding sandwich products wherein the receiving container is operationally compatible with the broiling member and the first product holding member; a toasting member for toasting baked goods such as sandwich buns; a second product holding member for holding toasted baked goods from the toasting member; an assembly board for assembling fast-food sandwiches from products taken from the first and second holding members; a steam generating assembly for increasing the temperature of products removed from the first or second holding members; and a heat staging member for maintaining sandwiches assembled at the assembly board at elevated temperatures. In the method of use of the invention, batch preparation of the sandwich products is utilized in the broiling, toasting, and first and second holding steps. Made-to-order preparation is utilized at the assembly board by taking the necessary ingredients from the first and second holding members.

### BACKGROUND OF THE INVENTION

1. Field of the Invention

The present invention relates to the field of food preparation. More particularly the invention relates to a combination and arrangement of fast-food kitchen apparatus and a method of assembling fast-food sandwiches. The invention is particularly suited for use in fast-food hamburger restaurants, although it may find use in any fast-food restaurant or short-order kitchen.

2. Description of the Related Art

Batch cooking has been known in the fast-food industry. Prior-art examples of batch processes for toasting bread products and for cooking meat products have been advantageous as they are less labor intensive and increase productivity over made-to-order products. Disadvantages to batch cooking include a perception of diminished product quality and therefore reduced customer satisfaction. Moreover, batch cooking can hinder menu flexibility as well as impede customization of individual orders (e.g. made-to-order variations of standard menu items).

In one known batch toasting process, a baked bread product is removed from a plastic bag and toasted, after which it is reinserted back into the plastic bag and placed in a dry convective heat holding cabinet to store the toasted bread product at desired temperature and humidity levels. This batch toasting process has been found to be disadvantageous because of the required intermediate step of removing from and then reinserting the bread product into the plastic bag, thereby leading to a consequent increase in labor and sandwich assembly time.

In another prior-art batch cooking process, broiled meat patties are held in a broiler in a receiving pan until a batch is completed. These meat patties are then transferred to a pan compatible with a holding cabinet. Because of the length of time necessary to broil different products and the inability to broil in whole batches, inconsistencies and a lack of uniformity may exist between products of any one batch. Moreover, the transfer from one pan to another is an inefficient and an unnecessary step that may lead to drying, discoloration, and overall diminished product quality.

In addition, the holding cabinets used to store products of these prior-art batch cooking processes have been deficient. Prior art holding cabinets, whether of the dry convective type or the steam cabinet type are more labor intensive, difficult to use, and potentially detrimental to product quality. Such prior-art holding cabinets have been unable to control humidity with precision due to the relatively large sliding or hinged doors required to load the batch cooked products thereinto and remove the batch cooked products therefrom. The opening and closing of these doors allows heat and humidity to escape from the unit. The same prior-art holding cabinets prevent different products from being held in the same unit under different conditions, thus restricting menu flexibility.

In one prior-art holding cabinet, individually heated and controlled passages are provided in the holding cabinet to increase menu flexibility and eliminate the need for the aforementioned relatively large and inefficient doors. The trays or holding pans used by these holding cabinets are not however compatible with other equipment in the fast-food kitchen and consequently introduce unnecessary steps of transferring products from one pan to another.

In one prior-art batch cooking process, toasted bread products and cooked meat products are stored together in a single holding cabinet. Though this decreases labor, the meat juices from the cooked meat product often seep into the toasted bread product adversely affecting the toasted bread product's flavor, appearance, and texture.

Batch assembly and storage of sandwiches (e.g. adding additional ingredients, sauces, condiments, and wrapping) has similarly been known in the fast-food industry. Batch assembly and batch storage of sandwiches after cooking the meat product and toasting the bread product has the same advantages of decreased labor and increased efficiency as well as disadvantages of decreased product quality and customer satisfaction and limited menu flexibility. Made-to-order assembly of sandwiches is often preferred by customers, has a perception of freshness and quality, and offers a variety of menu options. However, the disadvantages of made-to-order sandwich assembly include decreased efficiency and uncertain product uniformity. Consequently, batch assembly of fast-food sandwiches has been preferred by the fast-food industry.

A common problem of batch assembly and storage is the difficulty of maintaining the final assembled sandwich at a desired temperature before its ultimate sale. One prior-art batch assembly and storage process for sandwiches attempted to overcome this problem by heating certain elements of the sandwich (e.g. the bun and meat patty) above the preferred serving temperature with a microwave. This proved to be disadvantageous as microwave heating may lead to an undesirable, soggy taste and fail to uniformly heat the microwaved sandwich elements. Moreover, it has been observed in consumer preference studies that food products heated by microwave may not be perceived as fresh.

Other prior-art heating devices are deficient because they do not raise the temperature of the sandwich or sandwich ingredient fast enough, do not have the necessary speed or ease of operation for the fast-food industry, or are cost prohibitive for a franchise-based business model. Of the commercially available heating devices examined, heated contact plates that provide conductive heat to a sandwich do not raise sandwich temperatures quickly enough. Also the use of such plates on an assembly board in the fast paced environment of a fast-food kitchen is impractical. Convection based heating devices also do not raise sandwich temperatures fast enough and negatively affect sandwich quality. Infrared or lightwave heaters again do not raise the sandwich temperature to the desired level and are cost prohibitive. Conventional steam cabinets do not provide the needed product quality nor do they have the required speed or ease of operation.

The use of steam as a means of heating, while known, has heretofore not provided satisfactorily uniform results, particularly with respect to heating pre-processed food products such as baked goods, which may become soggy when exposed to a humid, steam environment. In prior-art steamers as well as in food holding cabinets using convective heating, it is difficult to control or maintain humidity at a desired level. Conventional steam cabinets also typically require time periods on the order of minutes to heat baked goods to temperatures in excess of 180° F. and even longer periods to heat broiled sandwich ingredients. Moreover, since these steamers and ovens typically have relatively large sliding or hinged doors to load food products therein and remove the food products therefrom, heat and humidity escape from the unit. Additionally, these doors introduce inefficient employee movement and wasted labor by the constant opening and closing of the doors during the assembly process of a sandwich. And such cabinets must be placed above or beside the sandwich assembly board—introducing even more inefficiency and wasted movement.

The necessary requirements of cooking, toasting, storing, assembling, and storing again pose inherent inefficiencies. Throughout the process of making a fast-food sandwich, operators in the fast-food kitchen must move between the many apparatus necessary to accomplish the above steps without interfering with each other or the accomplishment of the necessary step. In most prior-art arrangements of fast-food kitchens, products are taken in and out of multiple cabinets and heaters. This can prove to be labor intensive and detrimental to product uniformity.

It is also well known in the fast-food art to prepare sandwiches utilizing a division of labor. Ordinarily in batch assembly processes one employee at an assembly station prepares part of a fast-food sandwich and then hands the sandwich to a second employee who adds additional ingredients to the sandwich. This process is often repeated as necessary to assemble and wrap a complete sandwich ready for the consumer. This division of labor divides the product to be assembled between employees, (e.g. one employee assembles bun heels and meat patties while another prepares bun crowns and garnish while yet another employee wraps the sandwich) rather than dividing the equipment used in assembling the sandwich between employees, with each employee assembling a complete sandwich.

The positioning of holding cabinets, microwaves, and ingredient bins around the assembly area has previously limited the assembly of fast food sandwiches to a method using a division of labor wherein the product to be assembled is divided between different employees positioned in front of the necessary holding cabinets, steam cabinets and/or microwaves, and the various sandwich ingredients. Alternatively one employee would move down the length of the assembly board to assemble one sandwich. Whether utilizing a division of labor or a single employee walking the length of the board, the prior arrangement of holding cabinets, steam cabinets, and microwaves is plagued by inherent inefficiencies in assembling each sandwich, limiting the available methods used to assemble sandwiches and restricting menu options.

Sandwich assembly efficiency studies show that the most efficient method of assembling a sandwich divides the assembly process without dividing the product to be assembled. Prior art methods utilizing a division of labor that divides sandwich assembly between different employees yield a process that is 30-40% more efficient than one employee making the entire sandwich. Two employees making two sandwiches, wherein each employee is positioned at his or her own individual workstation, nearly doubles the sandwich assembly efficiency and productivity.

Individual workstations, however, have not been incorporated in previous kitchen arrangements because of the related increase in cost and space. Sharing certain equipment, such as the steam heating device included in the present invention, between employees without dividing the actual product to be assembled between multiple employees yields nearly 90% of the efficiency and productivity of individual workstations without the drawbacks of cost and space.

Consumer studies indicate that the average customer purchasing a fast-food sandwich at a counter within in a fast-food restaurant begins eating the fast-food sandwich approximately 2 to 3 minutes after purchase. But the average drive-through customer begins eating a fast-food sandwich approximately 7 minutes after purchasing a fast-food sandwich at the drive-through window. Consumer preference studies also show that customers prefer a fast-food sandwich when served at a temperature between the range of 150° F. to 160° F. Prior-art practices of cooking, heating, assembling, storing, and serving a sandwich have not been successful in maintaining a fresh tasting sandwich, within the desired serving temperature range of 150° F. to 160° F, for the period of time in which a consumer typically begins eating the sandwich, e.g. between approximately 2 to 7 minutes after purchase. In prior-art practices, to maintain this temperature, the quality of condiments and garnish was sacrificed, as condiment temperatures often reached 115° F, rather than the customer preferred temperature range of approximately 90° F. to 100° F.

It has therefore been found desirable to provide a batch cooking and storing process that integrates into a made-to-order sandwich assembly process that captures the advantages of labor savings, diminished waste, increased efficiency, improved product uniformity, quality and customer satisfaction, and better menu flexibility while avoiding the disadvantages of the aforementioned prior art.

### OBJECTS OF THE INVENTION

The foregoing demonstrates the need for a combination of kitchen equipment and method of use that achieves the advantages of batch preparation and made-to-order assembly while avoiding the disadvantages of both. Such combination and method must also be easy to use and have an associated cost that allows for incorporation into existing fast-food restaurants. Therefore, it is an object of the invention to provide a combination of kitchen equipment for a fast-food restaurant and method of use for assembling fast-food sandwiches in fast-food restaurants that avoids the aforementioned deficiencies of the prior art.

It is also an object of the invention to provide a combination and method that increases sandwich assembly efficiency through the use of batch preparation of certain sandwich ingredients.

It is another object of the invention to provide for a seamless transition from batch preparation of certain sandwich ingredients to made-to-order preparation and assembly of the remaining sandwich ingredients.

It is yet another object of the present invention to increase menu flexibility while decreasing waste of sandwich ingredients.

It is still another object of the invention to increase sandwich efficiency and quality by providing a common receiving and holding pan for most of the equipment in the combination envisioned.

It is yet another object of the invention to provide a combination of equipment that is easy to use and reduces labor costs and food product preparation and assembly time.

It is still another object of this invention to provide a combination of equipment and method of use for preparing batches of broiled sandwich ingredients, preparing batches of toasted baked goods, storing batches of sandwich ingredients, assembling fast-food sandwiches on a made-to-order basis, and serving fast-food sandwiches within the desired temperature range, all without sacrificing product quality.

It is also an object of the invention to provide a combination of equipment for storing and heating sandwich ingredients by means other than microwave heating while providing uniform heating throughout the desired food product without sacrificing product quality.

It is yet a further object of the invention to provide a method for using a combination of equipment that allows for increased efficiency and productivity in preparing sandwich ingredients and assembling fast-food sandwiches while avoiding the prohibitive cost and space requirements of individual workstations and the inefficiencies of dividing the assembly of one sandwich between multiple employees.

Various other objects, advantages and features of the present invention will become readily apparent from the ensuing detailed description and the novel features will be particularly pointed out in the appended claims.

### SUMMARY OF THE INVENTION

In order to achieve greater product assembly efficiency, improved product quality, and increased customer satisfaction, the preferred embodiment of the invention provides for a combination and arrangement of kitchen equipment to facilitate a combination of batch preparation and made-to-order assembly of fast-food sandwiches. Research indicates that the preferred embodiment of the invention achieves a 30% labor saving and reduces labor requirements during peak hours of operation in a fast-food kitchen.

Research also indicates that the invention improves sandwich quality and customer satisfaction over prior art practices. Cooked sandwich products, such as a meat patty, and toasted bread products, such as a bun, were previously stored together in the same holding cabinet, adversely affecting the quality of the bun. The juices of the cooked sandwich product often seeped into the bread product. And storing the bread product and the cooked sandwich product together required more heat to maintain the appropriate temperature than is required by the present invention. Moreover, in prior art arrangements, incompatible receiving and holding pans were used by the different pieces of kitchen equipment, creating inefficiencies of operation. Additionally, the broiling, toasting, and holding equipment were labor intensive, failed to provide the desired uniformity between products, and did not achieve the level of quality and/or customer satisfaction desired.

The different embodiments of the present invention overcome these difficulties by automating the broiling and toasting equipment and utilizing batch preparation of sandwich ingredients, providing a common holding pan, and holding sandwich ingredients as individual batches of products in product holding units and cabinets, while facilitating a made-to-order assembly process once the sandwich ingredients are brought to the assembly board.

The different embodiments combine the following equipment; namely: a freezer compartment for storing frozen sandwich ingredients; an automatic broiler for thawing, cooking, and finishing batches of sandwich ingredients taken from the freezer compartment; a universal carrying/holding tray for receiving batches of broiled or alternatively-cooked ingredients and holding the same batches of ingredients in holding cabinets at elevated temperatures for extended periods; a holding cart for holding untoasted baked goods such as sandwich buns; a vertical toaster for toasting sandwich bun halves; a steam cabinet with inserts for storing batches of toasted baked goods; an assembly board for assembling made-to-order sandwiches from the batch prepared ingredients; a steam generating assembly for heating sandwich components to elevated temperatures before assembling; and a heat chute for holding fully assembled sandwiches before serving the sandwich to the customer.

Utilizing any of the various embodiments of the present invention, a method for preparing sandwiches is provided which presents significant improvements over prior art methods.

### BRIEF DESCRIPTION OF THE DRAWINGS

The following detailed description, given by way of example but not intended to limit the invention solely to the specific embodiments described, may best be understood in conjunction with the accompanying drawings in which:

FIG. 1 is top layout view of a preferred embodiment of the fast-food sandwich preparation kitchen in accordance with the teachings of the present invention specifically showing the broiler, the food product holding unit, toaster, the steamer, the sandwich assembly station, the steam generating assembly, recessed ingredient bins, and the heat chute.

FIG. 2 is a front side layout view of the fast-food sandwich preparation kitchen of FIG. 1 specifically showing the broiler, the food product holding unit, toaster, the steamer, the sandwich assembly station, the steam generating assembly, recessed ingredient bins, and the heat chute.

FIG. 3 is a front elevational view of the automatic self-return broiler of the fast food preparation kitchen of FIGS. 1 and 2.

FIG. 4 is a side elevational view of the automatic, self-return broiler of the fast food sandwich preparation kitchen of FIGS. 1 and 2.

FIG. 5 is a detailed exploded top view of the tray insert for the food product holding unit and the automatic broiler, shown specifically with alternate solid and perforated tray lids used in the fast food sandwich preparation kitchen of FIGS. 1 and 2.

FIG. 6 is a front perspective view of the food product holding unit of the fast food sandwich preparation kitchen of FIGS. 1 and 2.

FIG. 7 is a side perspective view of the toaster with an accompanying bread product cart used in the fast food sandwich preparation kitchen of FIGS. I and 2.

FIG. 8 is a perspective view of the toaster of FIG. 7 with the top cover removed.

FIG. 9 is a detailed perspective view of the toasted bread products steamer used in the fast food sandwich preparation kitchen of FIGS. 1 and 2.

FIG. 10 is a rear perspective view of the toasted bread product steamer insert used in conjunction with the toasted bread products steamer of FIG. 9.

FIG. 11 is a front perspective view of a preferred embodiment of a steam generating assembly in accordance with the teachings of the present invention which is used in conjunction with the fast food sandwich preparation kitchen of FIGS. 1 and 2..

FIG. 12 is an exploded perspective view of the steam generating assembly of FIG. 11.

FIG. 13 is a top plan view of the steam generating assembly of FIG. 11.

FIG. 14 is front elevational view of the steam generating assembly of FIG. 11.

FIG. 15 is a side elevational view of the steam generating assembly of FIG. 11.

FIG. 16 is a perspective view of two steam generating assemblies constructed in accordance with the teachings of the present invention connected to a water supply and which can be used in conjunction with the fast food sandwich preparation kitchen of FIGS. 1 and 2.

FIG. 17a is a top plan view of the perforated target areas of the steam generating assembly of FIG. 11.

FIG. 17b is a bottom plan view of the perforated target areas of the steam generating assembly of FIG. 11.

FIG. 18 is a front perspective view of the steam generating assembly of FIG. 11 with an egg product adapter attached.

FIG. 19 is a front perspective view of the egg product adapter shown in the steam generating assemblies of FIG. 18 with the lid open.

### DETAILED DESCRIPTION OF CERTAIN PREFERRED EMBODIMENTS OF THE INVENTION

The fast food sandwich preparation kitchen of the present invention, as further described below, may preferably include the combination of: an automatic self-return broiler; a freezer compartment adjacent to the automatic self-return broiler; one or more food product trays for receiving batches of broiled food products from the automatic self-return broiler; a food product holding unit compatible with the receiving trays for holding batches of broiled food products at elevated temperatures, a bread product toaster; a toasted bread product steam holding unit for holding batches of toasted bread products at elevated temperatures; an assembly board for assembling made to order fast food sandwiches; a steam generating assembly for rapidly raising the temperature and humidity levels of toasted bread products taken from the toasted bread product steam holding unit; one or more sandwich ingredient bins; and a heat chute for storing fully assembled and wrapped, made-to-order sandwiches for immediate purchase by the consumer. A preferred method of use of the fast food sandwich preparation kitchen achieves the advantages of batch preparation and the flexibility of made-to-order preparation as described in more detail below.

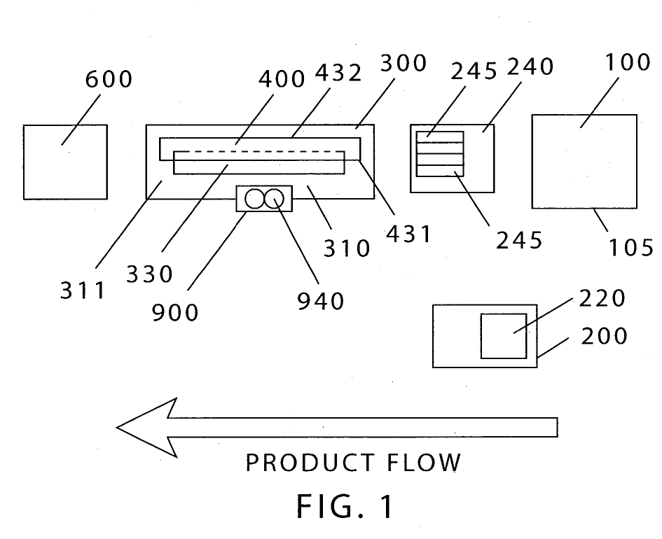

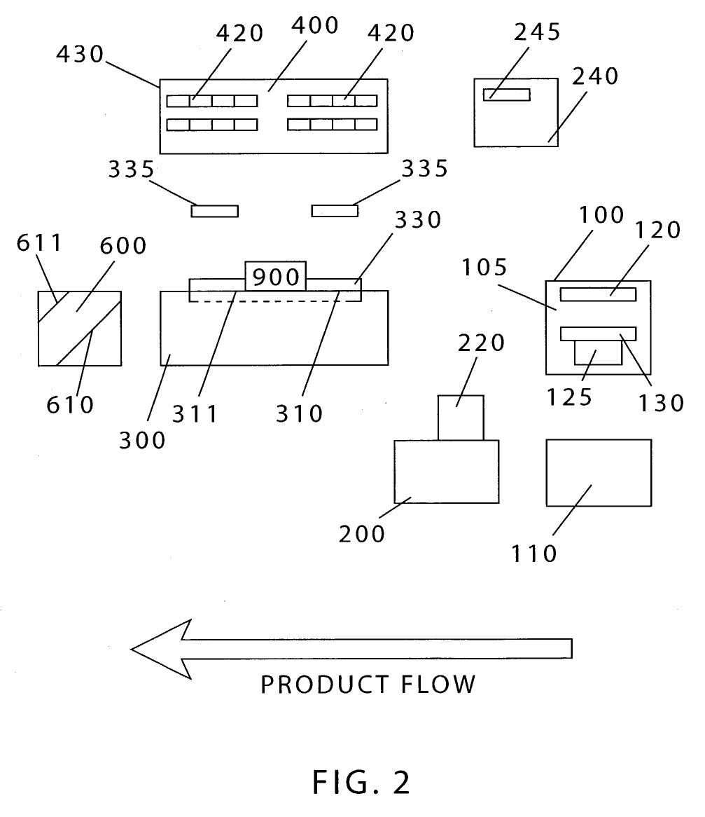

Referring now to FIGS. 1 and 2, wherein like reference numerals represent like features in the several views, in a preferred embodiment, frozen sandwich ingredients are broiled and held in batches to be used later in a made-to-order sandwich. Freezer compartment 110 is positioned underneath the working side 105 of self-return broiler 100. Freezer compartment 110 is of sufficient size and capacity to hold a variety of frozen sandwich ingredients, thus allowing for increased menu flexibility. Access to freezer compartment 110 is through a top sliding door (not shown) such that an employee may retrieve frozen sandwich product ingredients from freezer compartment 110 and position the frozen sandwich product ingredients in a stack at broiler inlet 120 with minimal movement in order to achieve increased labor efficiencies. An alternate embodiment of freezer compartment 110 may incorporate horizontal curtains or baffles through which an employee may retrieve frozen sandwich product ingredients.

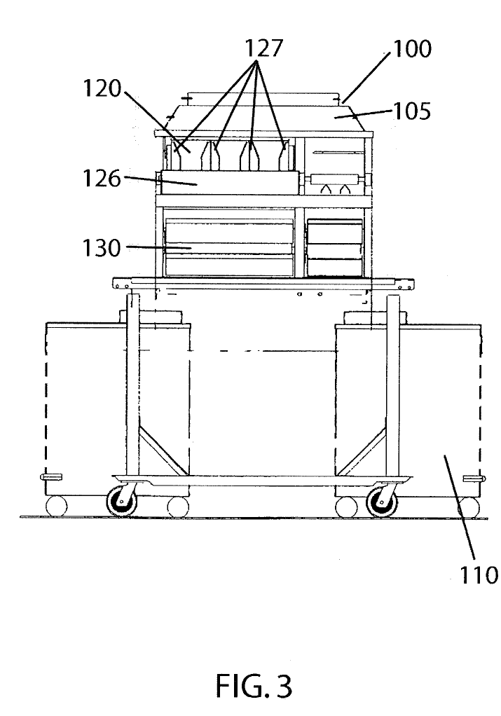

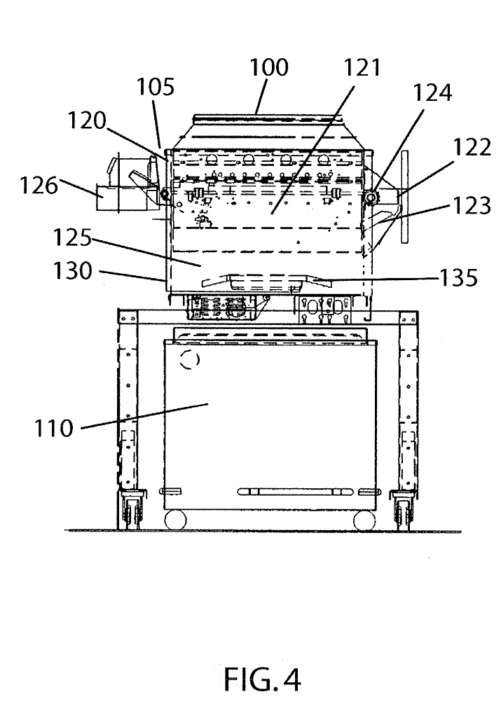

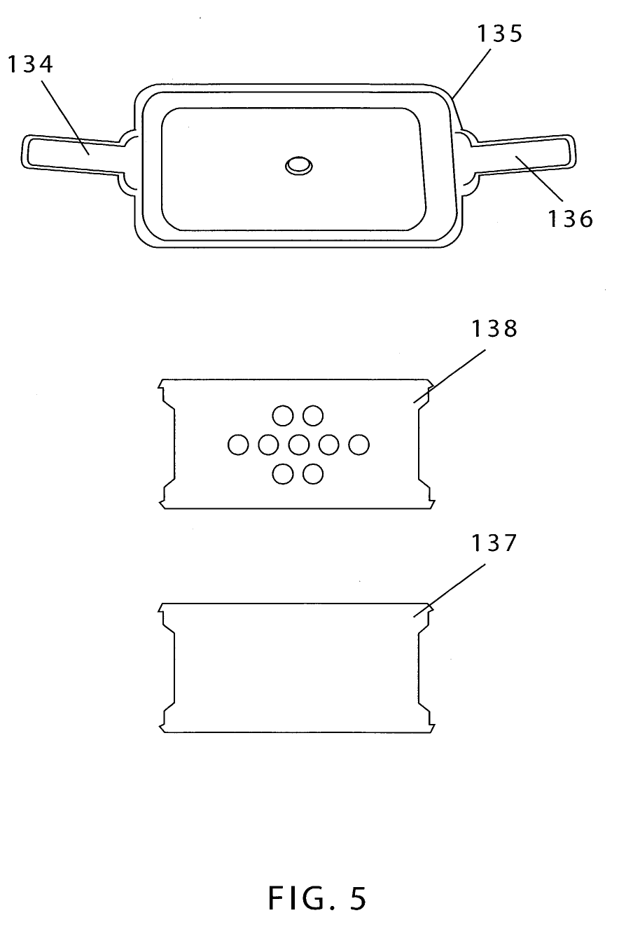

Referring to FIGS. 3 and 4, automatic, self-return broiler 100 is preferably of the chain broiler type and may incorporate: broiler inlet 120 at the upper portion of the working side 105 of the automatic broiler; chain cooking belt 121; a plurality of adjustable cooking zones along the conveyor chain to accomplish the necessary steps of thawing, cooking, and finishing broiled sandwich ingredients; back plate 122 and return slide 123 for returning broiled products from the terminal end of the chain cooking belt 124 to the working side 105 of the self-return broiler 100 through broiler outlet 130; heated holding area 125 for holding broiled products before transfer to product holding unit 400; and a control unit (not shown). Automatic, self-return broiler 100 and chain cooking belt 121 are preferably wide enough to accommodate multiple frozen sandwich products side-by-side on chain cooking belt 121 as fed from auto-loader 126, and most preferably, can accommodate three 5 inch meat patties side-by-side. Heated holding area 125 is preferably configured to receive product carrying/holding pans 135 (see FIG. 5).

An alternate embodiment incorporates multiple chain cooking belts 121 that may be independently controlled through the plurality of adjustable cooking zones. Additionally, each chain cooking belt 121 may have independently controlled adjustable cooking zones. Such an embodiment provides for parallel broiling of different sandwich ingredients, facilitates greater menu flexibility, and increases broiling efficiency.

Yet another alternate embodiment of the present invention incorporates an automatic, flow-through broiler wherein sandwich ingredients are discharged from the broiler on the opposite side from which the sandwich ingredients enter the broiling device. Such an embodiment may further incorporate a broiler inlet, an adjustable, chain cooking belt, a plurality of cooking zones to accomplish the necessary steps of thawing, cooking, and finishing broiled sandwich ingredients, a broiler outlet, a heated holding area that is capable of receiving broiled product carrying/holding pans 135 at the discharge end of the automatic, flow-through broiler, and a control unit.

An alternate embodiment of the automatic, flow-through broiler incorporates multiple chain cooking belts that may be independently controlled through the adjustable cooking zones. Additionally, each chain cooking belt may have independently controlled adjustable cooking zones. Such an embodiment provides for parallel broiling of different sandwich ingredients and facilitates greater menu flexibility.

A preferred embodiment of the invention incorporates auto-loader 126 at broiler inlet 120 on working side 105 of automatic, self-return broiler 100 or flow-through broiler. Auto-loader 126 is preferably in mechanical communication with chain cooking belt 121 such that auto-loader 126 feeds individual frozen sandwich products from a stack taken from freezer compartment 110 which are placed on auto-loader 126. Preferably auto-loader 126 feeds individual sandwich products onto chain cooking belt 121 at a rate equal to the chain speed of chain cooking belt 121. Stacks of frozen sandwich products placed on auto-loader 126 preferably form batches of sandwich ingredients. In a preferred use, batches of frozen sandwich ingredients may comprise either 12 meat patties of the 4 inch variety or 8 meat patties of the 5 inch variety. Auto-loader 126 may further incorporate stacking guides 127 to maintain batches of sandwich products in ordered stacks as auto-loader 126 feeds individual frozen sandwich ingredients from the stack onto chain cooking belt 121.

In a preferred embodiment, broiler outlet 130 is positioned at working side 105 of the automatic, self-return broiler and below broiler inlet 120. Heated holding area 125 may be integral with broiler outlet 130 and is preferably configured to receive the same number of product carrying/holding trays 135 placed side-by-side as the number of batches of frozen sandwich products that may be stacked side-by-side on auto-loader 126 and broiled on chain cooking belt 121. Product carrying/holding trays 135 are preferably positioned in heated holding area 125 to allow broiled products discharged from the terminal end of chain cooking belt 121 to slide down return slide 123 to broiler outlet 130 and into broiled product carrying/holding trays 135. Heated holding area 125 preferably maintains broiled sandwich ingredients in the broiled product carrying/holding trays 135 at a temperature in the range of approximately 160° F. to 170° F.

Product carrying/holding trays 135 are adaptable in a preferred embodiment of the invention, to be operationally compatible with automatic, self-return broiler 100, product holding unit 400 (further described below), and product adapter compartment 980 of steam heater 900 (also further described below). Product carrying/holding tray 135 provides a container to hold batches of broiled products either at heated holding area 125, or additionally, at product holding unit 400. Product carrying/holding trays may also hold batches of other sandwich products (e.g. fried products, deep fried products, steamed products, egg products, breaded products, etc.) that require holding within specified temperature and humidity ranges. Product carrying/holding tray 135 is preferably constructed of food grade thermoplastic material to facilitate employee handling while product carrying/holding tray 135 is held at elevated temperatures in heated holding area 125, product holding unit 400, or product adapter compartment 980.

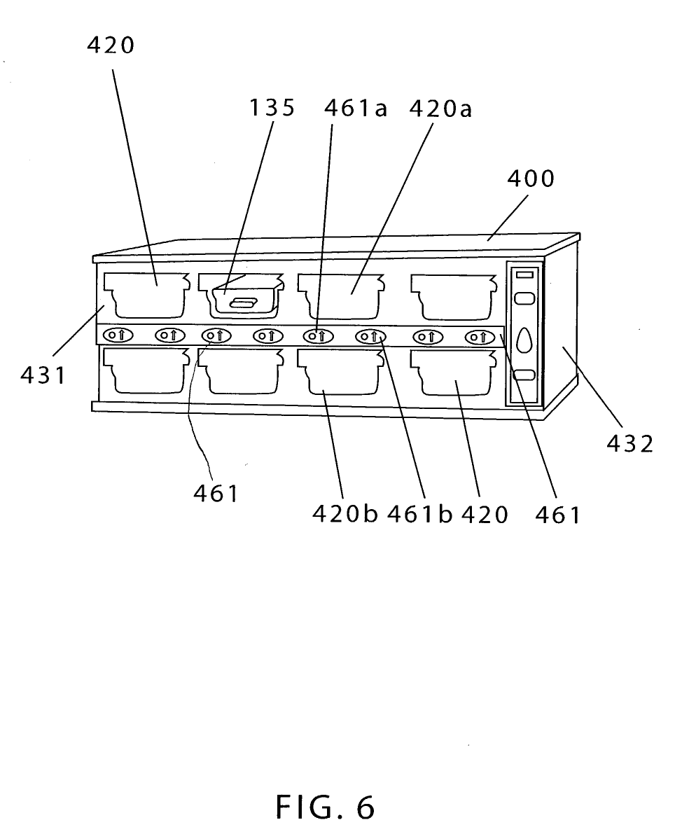

Referring now to FIG. 5, product carrying/holding tray 135 is preferably provided with handles 134 and 136. Handles 134 and 136 preferably are of the same molded material as product carrying/holding tray 135, and extend along the longitudinal axis of product carrying/holding tray 135. As shown in FIG. 5, these handles 134 and 136 protrude past the transverse sides of product carrying/holding tray 135. Handles 134 and 136 most preferably protrude beyond the planes formed by the front working side 431 and back working side 432 of product holding unit 400 (see FIG. 6) when product carrying/holding tray 135 is placed within a tray receiving compartment 420 of product holding unit 400.

Additionally, product carrying/holding tray 135 may be compatible with solid, broiled product lid 137 or perforated, alternate product lid 138. Broiled product lid 137 is preferably configured to cover the food cavity of product carrying/holding tray 135 and seal product carrying/holding tray 135 to maintain the desired humidity in product carrying/holding tray 135 when held within desired temperature ranges. Alternate product lid 138 is similarly configured to cover and seal the food cavity of product carrying/holding tray 135 but also incorporates perforations 139 so as to maintain the sandwich products at lower humidity than when using broiled product lid 137.

Referring now to FIG. 6, product holding unit 400 and product carrying/holding trays 135 allow pre-cooked food to be held for extended periods within desired temperature ranges while controlling humidity without noticeable degradation of product quality. Product holding unit 400 further facilitates batch storing of batch cooked sandwich products, simplifies kitchen operation, and eliminates waste.

Product holding unit 400 is preferably configured to receive product carrying/holding trays 135 in a plurality of self-contained, individually formed, and sealed tray receiving compartments 420. Tray receiving compartments 420 preferably are heated from the bottom and sides and heat sandwich products in product carrying/holding trays 135 by conduction. Broiled product lid 137 and alternate product lid 138 are removably mountable upon the food cavity of tray receiving compartment 420. With a product carrying/holding tray 135 covered by broiled product lid 137 or alternate product lid 138 inserted in tray receiving compartment 420, a seal is formed with product carrying/holding tray 135 when product carrying/holding tray 135 is inserted in tray receiving compartment 420. Removal of product carrying/holding tray 135 from tray receiving compartment 420 may preferably be done without removing broiled product lid 137 or alternate product lid 138 from tray receiving compartment 420.

The use of individually formed compartments with sealed trays reduces or eliminates food odor and taste transfer. Product holding unit 400 preferably further incorporates a pass-through design so that product carrying/holding trays 135 may be inserted into or removed from tray receiving compartment 420 from either the front working side 431 or the rear working side 432 of product holding unit 400.

In a preferred embodiment of the invention, product holding unit 400 contains a plurality of tray receiving compartments 420 arranged in rows and columns.

Product holding unit 400 may also be stacked or placed side-by-side with another product holding unit of similar design and is preferably placed on a shelf above sandwich assembly board 300 so that an employee at sandwich assembly board 300 need only reach from a horizontal surface at assembly station 310 or 311 to product holding unit 400 without moving laterally along sandwich assembly board 300.

In order to ensure that batches of sandwich ingredients first placed in the various tray receiving compartments 420 are used before later batches of sandwich ingredients placed in different tray receiving compartments 420, a preferred embodiment of the product holding cabinet 400 includes a product quality timer 460 to indicate which food product should be used first. Each of the tray compartments, such as 420a and 420b, is associated with a corresponding indicator light, such as 461a and 461b. When the indicator light 461 associated with a particular tray receiving compartment 420 is green, indicator light 461 indicates that the products making up the batch of sandwich ingredients in the product carrying/holding tray 135 held in that corresponding tray receiving compartment 420 should be used first. When the indicator light 461 is yellow, a newer batch of sandwich ingredients are in that corresponding product carrying/holding tray 135 in the corresponding tray receiving compartment 420 and a batch of sandwich ingredients in a tray receiving compartment 420 with a corresponding green indicator light 461 should be used before sandwich ingredients from a tray receiving compartment 420 with a yellow indicator light 461. When indicator light 461 flashes red, the batch of sandwich ingredients in the product carrying/holding tray 135 of the corresponding tray receiving compartment 420 has expired (i.e., the batch of sandwich ingredients have been held longer than the allowable preset maximum time). When indicator light 461 is a steady red light, no product is present in the corresponding compartment 420. Product quality timer 460 is preferably actuated by operator input, though it may alternatively incorporate automatic sensors. A control unit (not shown) preferably tracks times for each tray receiving compartment 420 after initial operator input and controls the appropriate light display. In addition to or in place of the red/yellow/green indicator lights described, product quality timer 460 may utilize other visual and/or audio indicating means known in the art.

When batches of sandwich ingredients are placed in product holding unit 400 and the batch hold times are tracked by product quality timer 460, the batch cooking process for the broiled and alternatively cooked (e.g. fried, deep fried, steamed, etc.) sandwich ingredients is completed. When the broiled or alternatively cooked sandwich ingredients are removed from the product holding unit 400, such sandwich ingredients are incorporated into a made-to-order process (further described below).

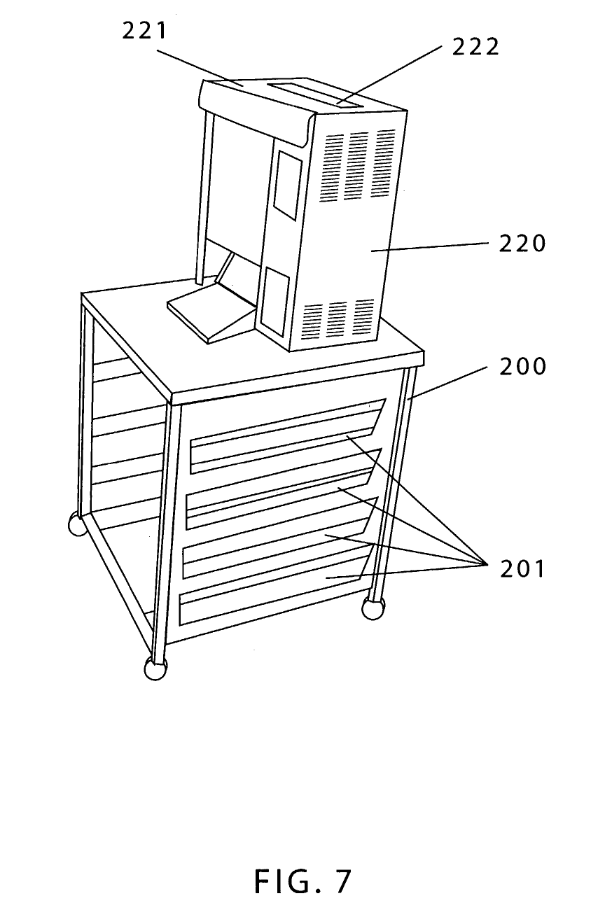

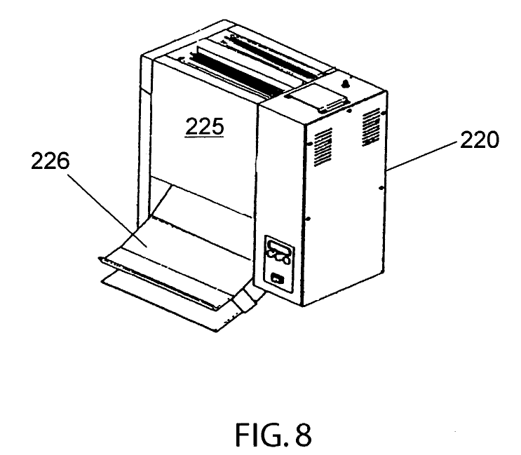

Referring now to FIGS. 7 and 8, in a preferred embodiment, baked goods, such as sandwich buns, are toasted and held in batches to be used later in a made-to-order sandwich. Baked good holding cart 200 provides a portable platform for a toaster 220, such as a vertical toaster and includes multiple holding racks 201 for holding trays of prebaked or prepackaged baked goods such as sandwich buns. Baked good holding cart 200 and toaster 220 may be positioned adjacent to toasted baked good steamer 240 to facilitate batch toasting and holding, or alternatively, may be placed adjacent to assembly board 300 and proximate to steam generating assembly 900 to facilitate made-to-order toasting and sandwich assembly when demand does not warrant holding batches of toasted baked goods.

Toaster 220 is preferably a contact vertical toaster and most preferably may incorporate top heat shield 221, toaster inlet 222, heated platen 223, dual conveyors for conveying baked goods along a heated surface in a downward motion, conveyor covers 225, exit chute 226, and a control unit (not shown). Toaster 220 may also utilize an automatic bun feeder (not shown) or may alternatively be manually fed. In an alternate embodiment exit chute 226 may feed toasted heal and crown baked good pairs into baked good steamer insert 245.

In a preferred use, baked goods such as sandwich buns are fed into toaster inlet 222 as a matched pair of heal and crown. Conveyors may convey the bun heal and bun crown at approximately the same speed so that the heal and crown exit vertical toaster 220 via exit chute 226 approximately at the same time, thus keeping bun crown and heal pairs together. Alternatively, the conveyors may convey the heal and crown at different speeds. Toaster 220 preferably has a capacity to toast approximately 12 heal and crown baked good pairs per minute and most preferably has a capacity to toast 14 five inch sandwich buns per minute. A control unit on toaster 220 preferably controls the temperature of heated surface that may be adjustably set between 350° F. to 650° F., and is most preferably set at approximately 600° F. The speed of conveyors may also be adjustably set. In a preferred use, 4-inch hamburger buns exit vertical toaster 220 at an average temperature in the range of approximately 140° F. to 150° F. and the cut sides of the bun heal and bun crown are uniformly toasted.

Toaster 220 preferably has the flexibility to toast baked goods in batches or on demand to support made-to-order sandwiches. When toasting baked goods on-demand, toaster 220 and baked goods holding cart 220 are rolled adjacent to assembly board 300 and steam generating assembly 900 so that an employee at assembly board 300 is able to toast the needed baked good and assemble a sandwich without moving laterally along assembly board 300, thus facilitating decreased labor and increased sandwich assembly efficiency. The flexibility to operate in an on-demand mode or as a batch toaster further eliminates waste and increases menu options.

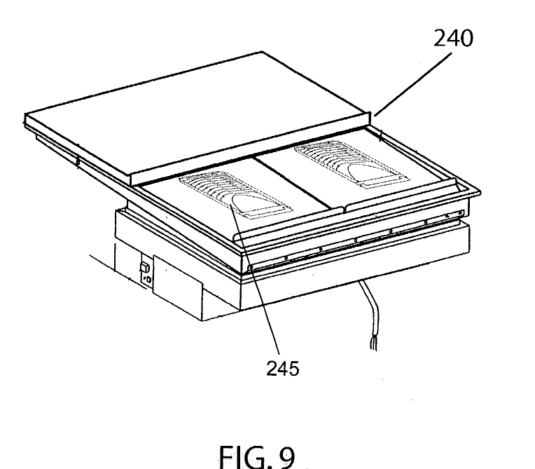

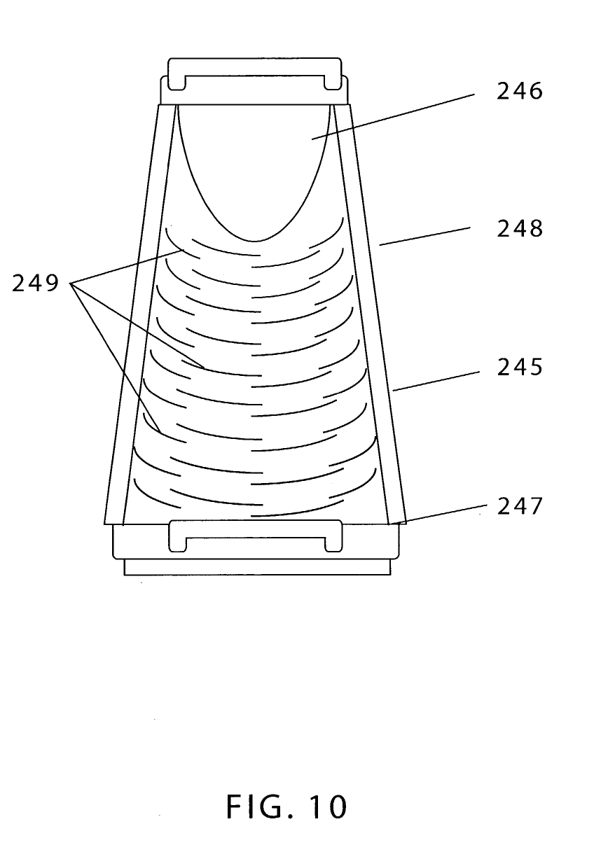

Referring now to FIGS. 9 and 10, in a preferred embodiment to toast and hold baked goods for extended periods, toaster 220 is used in combination with baked goods steamer 240. Toasted baked goods held in baked goods steamer 240 are preferably used later in made-to-order sandwiches. Baked goods steamer 240 is a conventional steamer design, of the type known in the art, but is capable of holding multiple baked goods steamer inserts 245 and is most preferably capable of holding at least three baked goods steamer inserts 245. Baked goods steamer 240 also preferably maintains toasted baked goods such as sandwich buns at desired humidity levels and elevated temperatures between the range of approximately 100° F. to 160° F., and most preferably at approximately 130° F., without degradation to product quality, texture or taste. Baked goods steamer 240 is preferably positioned adjacent or proximate to assembly board 300 such that baked goods in the baked goods steamer insert 245 can be readily and rapidly transferred onto the assembly board 300 (see FIG. 1).

In a preferred embodiment, baked goods steamer insert 245 is designed to receive batches of toasted baked goods, such as sandwich buns, wherein individual pairs of bun heels and crowns are shingled, angled in a row successively, against the other pairs of bun heels and crowns. Baked goods steamer insert 245 further incorporates an inwardly sloping front side 246 to facilitate shingling of baked goods, a substantially vertical back side 247, and rounded midsection 248. Baked goods placed in rounded midsection 248 are in fluid communication with the ambient environment through open slots 249. Alternate embodiments of rounded midsection 247 may incorporate mesh, perforations, or other means of exposing baked goods held in round midsection 247 to the ambient conditions.

In order to ensure that a batch of toasted baked goods held in baked goods steamer insert 245 and first placed in baked goods steamer 240 is used before later batches of baked goods held in additional baked goods steamer inserts 245 and later placed in baked goods steamer 240, a preferred embodiment of baked goods steamer 240 includes a product quality timer (not shown), similar to product quality timer 460 used with product holding unit 400. An indicator light on the product quality timer associated with a corresponding baked goods steamer insert 245 preferably uses the same green/yellow/red indicating system as previously described. The product quality timer associated with baked goods steamer 240 is preferably actuated by operator input though it may alternatively incorporate automatic sensors. A control unit (not shown) preferably tracks times for each baked goods steamer insert 245 after initial operator input and controls the appropriate light display.

When batches of toasted baked goods are placed in baked goods steamer 240 and the batch hold times are tracked by the associated product quality timer, the batch toasting and holding process for the baked goods is completed. When the toasted baked goods are removed from the baked goods steamer 240, such baked goods are incorporated into a made-to-order process (further described below).

In a preferred embodiment of the invention, made-to-order sandwiches are prepared at assembly board 300 from batches of broiled or alternatively cooked products held in product holding unit 400, from toasted sandwich buns held in baked goods steamer 240, from sandwich ingredient bins 330, and utilizing steam generating assembly 900. In an alternate embodiment, sandwich buns may be toasted on-demand from vertical toaster 220 as described above.

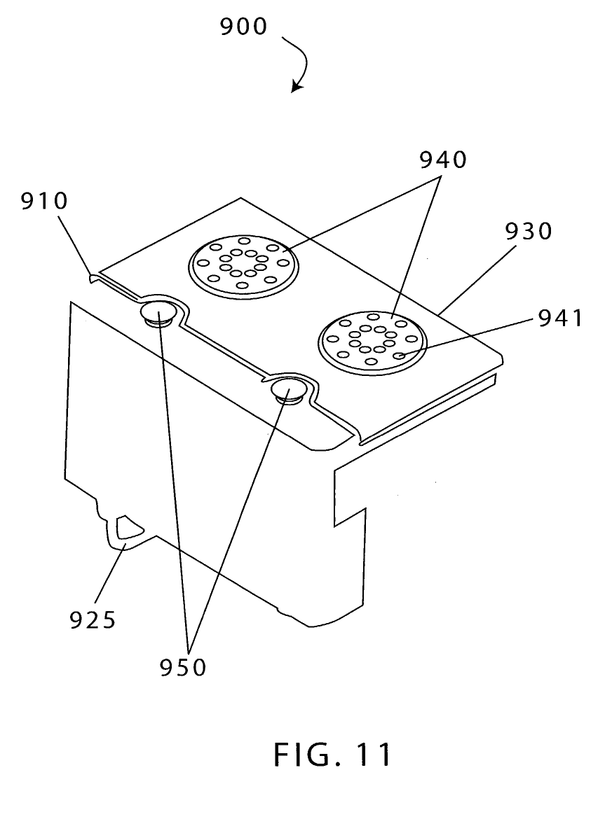

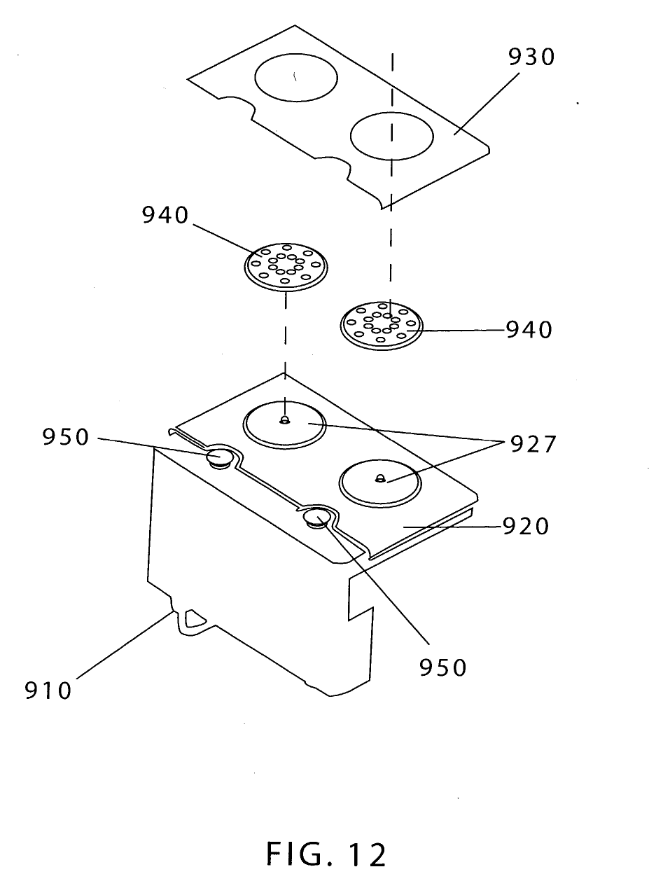

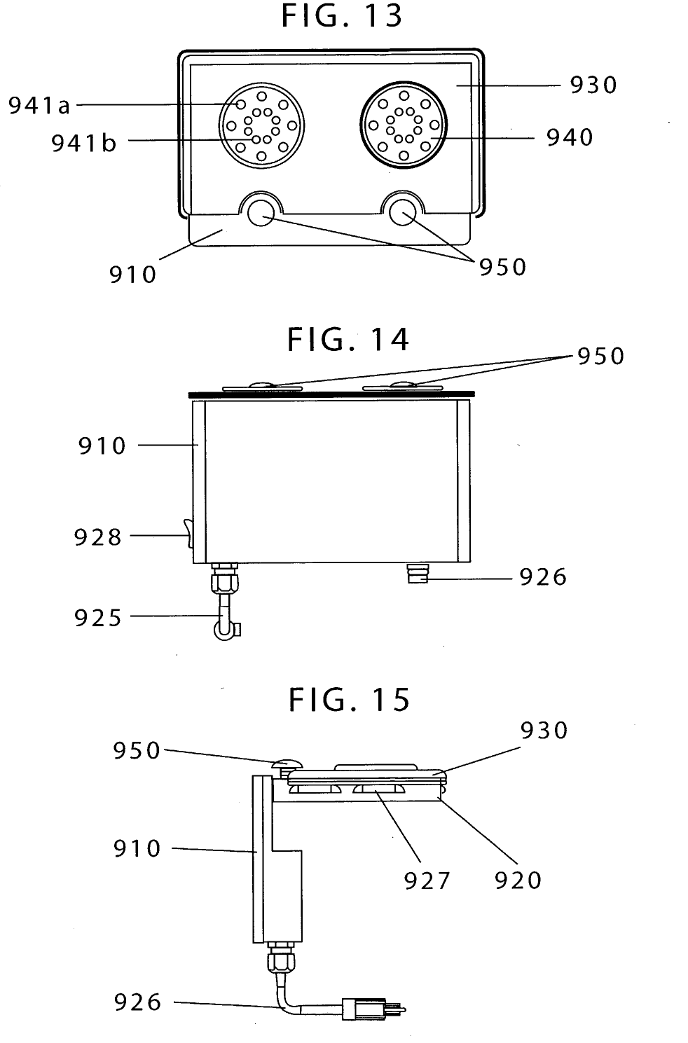

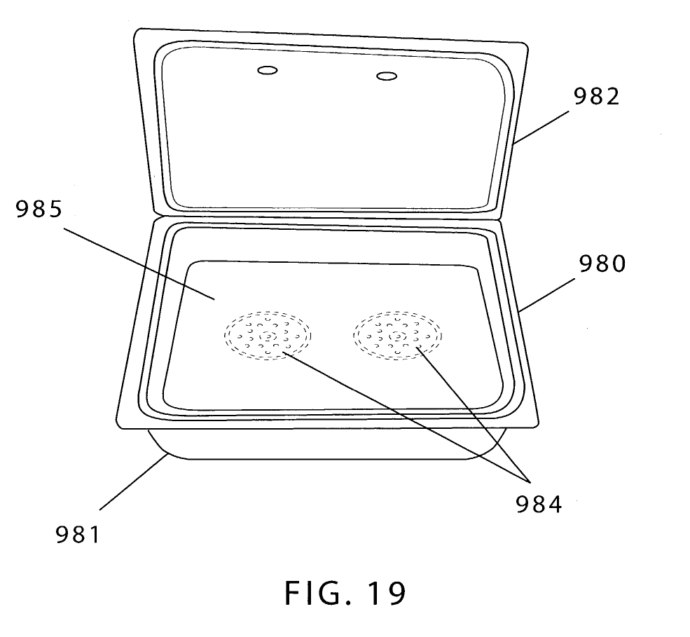

Referring now to FIGS. 11 through 19, in one embodiment of the invention, a steam generating assembly 900 of the fast-food sandwich preparation kitchen of the present invention includes steam module housing 910, supply source 920, heat shield 930, perforated target area(s) 940, actuation button(s) 950 and a control module (not shown). Preferably, steam module housing 910 is configured to be mounted to assembly board 300 by mounting steam module housing 910 around the front edge of assembly board 300. The system is notched to allow control modules, water/steam supply, pumps, solenoids and the like to be housed underneath the front edge or lip of assembly board 300. In alternate embodiments, the system may have an adjustable notch to fit on different sized assembly boards. Steam generating assembly 900 is preferably mounted in the middle of assembly board 300 at the front edge or lip so as to separate a first assembly station 310 and a second assembly station 311 (see FIGS. 1 and 2).

In a preferred embodiment, supply source 920 is connected to water feed 925 and power supply 926. Water Feed 925 is preferably connected to supply source 120 via a passage or tube 929 through steam module housing 910. Water feed 925 is preferably composed of food grade hose and may be fed by a remote pump module 990, water regulator or a direct water line hook-up. An alternate embodiment incorporating a direct water line hook-up for water feed 925 may also incorporate a regulator or other means of controlling water pressure.

In a preferred embodiment, steam is generated when water is released at supply source 920 onto heated steam generator surface 927 producing low pressure steam. Water feed 925 delivers an adjustable volume of water, preferably from 3 to 8 grams, and most preferably 4.5 grams, to generator surface 927. Water is delivered to generator surface 927 over a period of time, preferably 0.4 seconds for 4.5 grams, of water, such that the water flashes to steam and the steam is delivered to the food product within approximately 5 seconds after activation. In order to flash the preferred quantity of water into steam in the preferred time period, generator surface 927 is adjustably set to reach a temperature of between preferably 280° F. and 360° F.

In an alternate embodiment, the volume of water can be adjusted to predetermined amounts to deliver greater or lesser quantities of steam over various predetermined time periods, thus allowing for product flexibility. For example, if egg products are to be steamed, a switch would preferably release 9 grams of water from water feed 925 over 0.8 seconds to the generator surface 927 yielding 10 seconds of steam to the egg products. The switch could then be reset to deliver the preferred 4.5 grams of water from water feed 925 over 0.4 seconds to the generator surface 927, yielding 5 seconds of steam appropriate for bread products. In another alternate embodiment, steam may be generated remotely and delivered to steam source 920 via water feed 925.

Power supply 926 supplies electrical power, preferably 125 volt 60 hz, to generator surface 927 of steam source 920. In alternative embodiments of the invention, steam may be generated by any other conventional steam generating means. Steam generating assembly 900 may also be provided with on/off power switch 928 connected to power supply 926. Power switch 928 preferably includes a ready indicating light, indicating operational readiness.

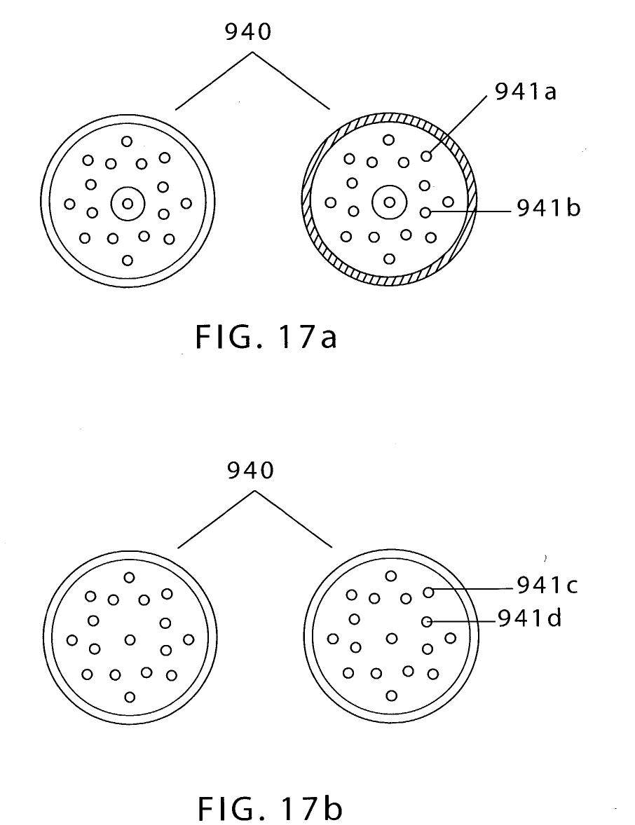

In a preferred use, an adjustable amount of water is controllably released through supply source 920 onto steam generator surface 927, thus producing an adjustable, controlled release of steam to target area 940 over a period of time between the range of 3 to 10 seconds, and most preferably 5 seconds. Target area 940 contains a plurality of perforations 941, such as 941a and 941b, of sufficient predetermined pattern and size through which steam is delivered via atmospheric up-shoot to a desired food product at an average pressure of approximately 6 psi. The desired food product is heated by convection and conduction of the steam. The dimensions and arrangement of target area 940 and perforations 941 in the preferred embodiment maximize available steam area to a 4 inch bun while also effectively steaming a 5 inch bun. In order to deliver steam uniformly to the desired food product, perforations 941 should be evenly spaced and distributed on the target area 940. The total area of the perforations 941 should be approximately in the range of 25% to 45% of the surface area of the bun surface in contact with target area 940. Referring to FIG. 17a, in a preferred embodiment, target area 940 is approximately 3.5 inches in diameter and preferably includes two concentric circles 941a and 941b of at least 8 evenly spaced perforations 941 each, wherein perforations 941 are preferably 5/16 inch in diameter. Referring to FIG. 17b, in an alternate embodiment a random arrangement of evenly spaced perforations 941 may be used. In a further alternate embodiment, a grid pattern of perforations may be used. The diameter of individual perforations 941 may vary between perforations 941c and 941d, as may the pattern of distribution of perforations 941 so long as uniform heating of a sandwich bun or other food product is achieved.

Target area 940 is also preferably sized to prevent accidental operator contact with target area 940, and is ideally sized so that the desired food product (e.g. a sandwich bun) to be steam heated overlaps target area 940. The surface of target area 940 should also preferably be raised above the surface of heat shield 930 such that the portion of the food product that overlaps target area 940 is not in contact with heat shield 930. Further to achieve a safe and easy system to operate, target area 940 and heat shield 930 are preferably made from a high temperature resistant, food grade material of low conductivity such as ULTEM, to minimize residual heat after use and prevent burning the operator. Preferably for reasons of safety, no surface of steam generating assembly 900 in contact with the operator should exceed 140° F.

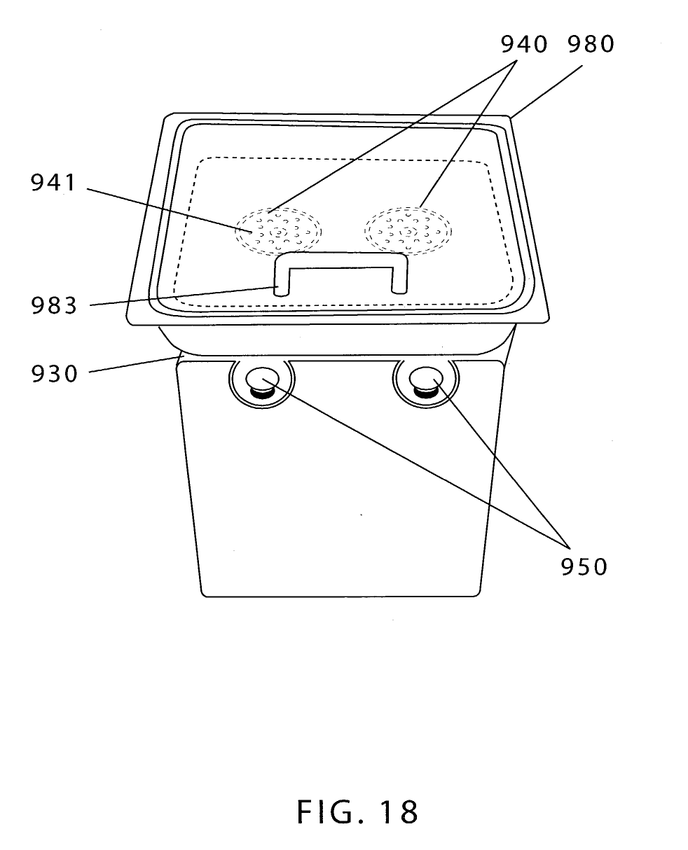

In an alternate embodiment as shown in FIG. 18, heat shield 930 may be removed from steam module housing 910 and replaced with product adapter compartment 980 for heating batches of egg products and the like. Target areas 940 are preferably the same as those described in FIG. 17a and 17b. Product adapter compartment 980 preferably includes housing 981, housing lid 982, housing lid handle 983, target area cutouts 984, and heat conductive plate 985. Housing lid 982 is preferably sized and shaped such that a minimal amount of steam escapes from housing 981 to the kitchen environment when housing lid 982 is placed on housing 981 and steam generating assembly 900 is actuated. Product adapter 980 is preferably sized and shaped to accept product carrying/holding trays 135. Food products, such as batches of egg products, are cooked within product adapter compartment 980 when steam is released through perforations 941, as previously described, and the steam is contained in the closed product adapter compartment 980.

Actuation button(s) 950 control(s) the delivery of water or steam to steam source 920. In one embodiment, the delivery of steam to each target area 940 is initiated by its own actuation button 950. In another embodiment, one actuation button 950 may initiate the delivery of steam to more than one target area 940. Most preferably, actuation buttons 950 can be controlled so that steam is not delivered to target areas not in use in order to limit the amount of residual steam released and minimize the risk of bums to the operator. In an alternative embodiment, actuation button(s) 950 may be connected to or replaced by alternate actuation means including a foot switch, hip switch, etc., or the delivery of water or steam may be automatically actuated by the presence of the food product on target area 940. In addition, actuation button 950 may be connected to a ready indicating light or audible signal to indicate steam cycle readiness.

A control module (not shown) adjustably controls various functions that support steam generating assembly 900 including, e.g., timing cycle, water volume delivery, generator surface temperature. Steam generating assembly 900 may also be provided with audio and/or visual indicators to signal unit readiness, end of the steam delivery cycle, steam cycle readiness, etc. The control module is preferably set so that, under normal operation, no residual steam is emitted from steam generating assembly 900 three seconds after the end of the steam delivery cycle. The recovery time of steam generating assembly 900 is preferably set to allow for a new cycle within five seconds after completion of the previous cycle. Most preferably, steam generating assembly 900 is set to be at temperature and ready to function correctly after 20 consecutive cycles 8 seconds apart.

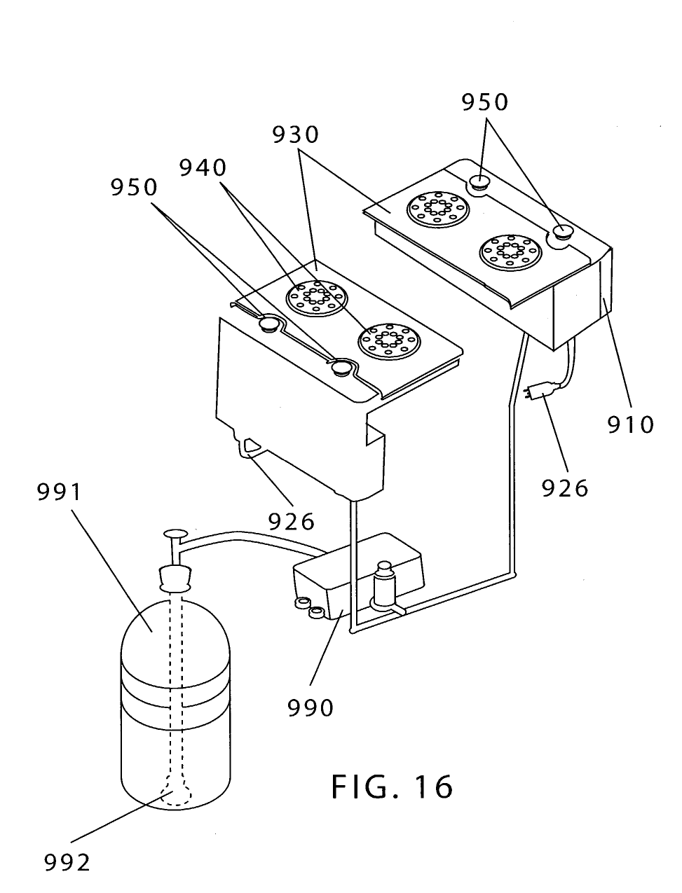

In one preferred embodiment shown in FIG. 16, two steam generating assemblies 900 are connected to pump module 990. Pump module 990 is fluidly connected to water source 991 via pump supply 992. Preferably, each steam generating assembly 900 has its own power on/off switch 928.

In a preferred method of use steam generating assembly 900 may be used in the preparation of fast-food sandwiches such as hamburgers, breakfast sandwiches, hot sandwiches, and the like to be served at preferred temperatures ranging from 150° F. to 160° F. Use of the steam generating assembly 900 reduces sandwich assembly times over conventional microwave processes, improves product quality, and leads to increased customer satisfaction.

In a preferred method of heating a food product (e.g. a bun half), an employee places a toasted sandwich bun heal on target area 940 of steam generating assembly 900. Depressing actuation button 950 releases a controlled quantity of steam through perforations 941, thereby rapidly heating the product by exposure to the steam. Unlike prior-art microwave heating, exposure to steam through the perforations 941 of target area 940 leads to uniform heating of the entire exposed surface of the toasted sandwich bun heal.

In a preferred method of use, the heel of a toasted sandwich bun taken from baked goods steamer 240 is heated from a temperature of about 130° F. to a temperature of about 190° F. in a period of approximately 5 seconds with low-pressure steam. In an alternate use, the heel of a toasted sandwich bun removed from vertical toaster 220 is heated from a temperature of about 145° F. to a temperature of about 190° F in the same time period with the same low-pressure steam. By quickly raising the temperature to above the desired serving temperature range of between 150° F. to 160° F., the bun heel retains its temperature enough to keep the average overall serving temperature of the sandwich in the range of approximately 150° F. to 160° F.

While the bun heel is steamed, preferably by placement on the generating assembly 900 cut side down, an employee operating the steam generating assembly 900 preferably completes the assembly of the ingredients to be placed on the crown of the sandwich bun. In a preferred method, an employee removes a sandwich wrapping from sandwich wrapping dispenser 335 and places the sandwich wrapping on assembly board 300 adjacent to steam generating assembly 900 and at assembly station 310 or 311. The crown of the sandwich bun is placed in the middle of the selected wrapping for the sandwich. Required ingredients from the group comprising lettuce, tomatoes, pickles, onions, and condiment sauces are then added to the sandwich bun crown from ingredients bins 330. Alternate sandwich ingredients may be added as menu options change.

When the steaming cycle at steam generating assembly 900 is completed, the employee finishes the sandwich assembly by adding broiled or alternatively cooked ingredients from product holding unit 400 to the sandwich bun heel. If cheese is required for the ordered sandwich, it is preferably taken from the appropriate sandwich ingredient bin 330 and placed on top of the broiled or alternatively cooked sandwich ingredient just placed on top of the sandwich bun heal. The employee then preferably closes the sandwich by placing the bun heel with its accompanying ingredients on top of the bun crown with its accompanying ingredients. The employee then preferably wraps with the sandwich wrapping and places the sandwich in heat chute 600.

In a preferred method, the time required to assemble the remaining sandwich ingredients on the bun crown while the bun heel is being steamed at steam generating assembly 900 should exceed the time set to steam the bun heel. This ensures that the employee will not pick the bun heel off the steam generating assembly while the bun heel is still being steamed.

The preferred method of use decreases sandwich assembly times over the prior art and provides for a uniformly heated sandwich that will maintain its serving temperature in the preferred range of 150° F. to 160° F. for at least 10 minutes after assembly is completed. Preferably, a broiled product is placed directly on the steam heated bun heel, thereby ensuring that the majority of the heat from the bun is transferred to the broiled product placed on top of the steam heated bun instead of to the condiments, which lay on top of the broiled product. The broiled product serves as a thermal barrier between the heated bun heel and the top or crown portion of the sandwich. This ensures the overall sandwich serving temperature is maintained in the preferred range of 150° F. to 160° F. over a period of 10 minutes or more while the condiment temperature does not exceed 105° F. in the same time period.

In a preferred embodiment, ingredients bins 330 are recessed in assembly board 300 located inward from the edge of assembly board 300 so as to create a substantially horizontal and clear working space for an employee at assembly stations 310 or 311. Ingredients bins 330 are also preferably placed underneath product holding units 400. Sandwich wrapper dispenser 335 is preferably placed in the space underneath product holding units 400 yet above ingredient bins 330.

In an alternate method of use, two sandwiches are assembled by a first and second employee wherein steam generating assembly 900 is shared between the first employee assembling sandwiches at assembly station 310 and a second employee assembling sandwiches at assembly station 311. This method divides the process for assembling sandwiches between employees without dividing the sandwich between employees.

The method begins with the first and second employees each removing one appropriate sandwich wrapper from sandwich wrapper dispenser 335 located at separate assembly stations 310 and 311 and placing the sandwich wrapping on assembly board 300 adjacent to steam generating assembly 900 and at assembly station 310 and 311. First employee then preferably removes two sandwich bun heel and crown pairs from baked goods steamer 240, hands one crown to the second employee, places two bun heals on steam generating assembly 900 and actuates the steam cycle via actuation button(s) 950. The first employee then places the remaining bun crown on the sandwich wrapping on assembly board 300 at assembly station 310 and completes the assembly of the sandwich as described previously, using one of the two bun heals on steam generating assembly 900 in the process. The first employee places the fully assembled and wrapped sandwich on assembly board 300 adjacent to steam generating assembly 900 at point 350 rather than placing the fully assembled and wrapped sandwich on heat chute 600 as described previously. After the first employee hands the bun crown to the second employee, the second employee places the same bun crown on the sandwich wrapping on assembly board 300 at assembly station 311 and completes the assembly of the sandwich as aforementioned, using one of the two bun heals on steam generating assembly 900 in the process. When the second employee has fully assembled the sandwich at assembly station 311, the second employee moves both the sandwich placed at point 350 by the first employee and the fully assembled and wrapped sandwich prepared by the second employee to heat chute 600. This method of use eliminates wasted movement by the two employees, allowing each employee to remain generally at the employees' respective assembly station, thus increasing sandwich assembly efficiency.

In a preferred embodiment, heat chute 600 is ideally located adjacent to assembly board 300 and opposite baked goods steamer 240. Heat chute 600 may be of any conventional design, and most preferably allows for individual adjustment and control of lower inclined heated surface 610 and upper inclined heating elements 611 (see FIG. 2). In a preferred use, heated surface 610 is maintained at a temperature in the range of 110° F. to 180° F. Upper heating elements are preferably maintained at a temperature in the range of approximately 90° F. to 160° F. This allows the fully assembled sandwich placed on lower heated surface 600 to maintain the heat characteristics provided by steam generating assembly 900 so that the average serving temperature of the sandwich is in the range of approximately 150° F. to 160° F. for at least 10 minutes after assembly and before serving the sandwich to the customer. Most preferably, by setting upper heating element 611 at a temperature below the temperature of lower heated surface 610, the sandwich ingredients placed on top of the broiled or alternatively-cooked sandwich product do not exceed a temperature of 115° F. Thus the hottest part of the sandwich comprises the bun heal and the broiled or alternatively-cooked ingredient and the coolest part of the sandwich comprises the bun crown and the remaining ingredients.

The fast food sandwich preparation kitchen of the present invention uses a combination of equipment to obtain the benefits of batch processing while achieving the advantages and flexibility of made-to-order sandwich assembly. In the preferred embodiment and method of use, batches of frozen sandwich products, such as meat patties, are removed from a freezer compartment and placed on an auto-loader of an automatic self-return broiler. The freezer compartment is preferably located adjacent to or below the automatic self-return broiler.

Once a batch of frozen sandwich products is placed at the auto-loader the automatic self-return broiler thaws, broils, and finishes the sandwich products, discharging the sandwich products into receiving trays. The receiving trays are compatible with a product holding unit. When the batch of sandwich products is discharged into the receiving tray and the receiving tray is placed into a heated compartment of the food product holding unit, batch processing of the sandwich product, such as meat patties, is complete.

The food product holding unit is preferably configured to receive multiple receiving trays. Moreover, the food product holding unit preferably may heat each tray individually and track holding times for each tray.

Proximal to the broiler and the product holding unit, a vertical toaster is preferably mounted to a movable cart. The vertical toaster most preferably can toast batches of bread products such as sandwich buns, but may also toast bread products in an on-demand mode to facilitate made-to-order sandwiches when demand does not require batches of toasted bread products.

After a batch of toasted bread products is completed, the batch is preferably stored in a toasted bread product steamer at temperatures and humidity levels above ambient conditions. The toasted bread product steamer is also preferably capable of holding multiple batches of toasted bread products and tracking the hold time of each batch. When batches of toasted bread products are stored in the toasted bread product steamer, batch processing of the bread products is completed.

The employees in the fast food sandwich preparation kitchen may incorporate a variety of methods to fully assemble made-to-order sandwiches utilizing an assembly board, a steam generating apparatus, sandwich ingredient bins, the aforementioned food product holding unit and toasted bread product steamer, and a conventional heat chute.

Preferably an employee places a sandwich wrapper at a predetermined work station adjacent to the steam generating assembly located on the assembly board. The employee then retrieves a sandwich bun and heal pair from the toasted bread product steamer and places the heal on the target area of the steam generating assembly. The crown of sandwich is placed on the sandwich wrapper. The employee then initiates the steam generating assembly and proceeds to assemble the crown of the sandwich with various sandwich ingredients and condiments. After the heal of the sandwich has undergone a steam cycle from the steam generating assembly, the employee removes a broiled sandwich product, such as a meat patty, from the food product holding unit and places it on the heal of the sandwich bun. The elevated temperature of the heal serves to keep the meat patty warm until consumption.

The heal portion of the bun, including the meat patty, and the crown portion of the bun, including the remaining sandwich ingredients, are placed together to form a completed and fully assembled sandwich. The sandwich is then wrapped and placed on the heat chute, ready for purchase by the consumer. During periods of increased demand, variations of this method may be used as more fully described above.

Accordingly, for those reasons set forth above, the present invention provides a combination of kitchen equipment and a method of use that achieves the many benefits of batch processing while integrating seamlessly into made-to-order assembled sandwiches from the batch prepared ingredients, thus avoiding the aforementioned drawbacks of batch and made-to-order sandwich preparation. Additionally, the present invention decreases labor requirements in the kitchen, increases sandwich assembly and preparation efficiency, improves product quality and uniformity, and provides a combination of equipment and a method of use that are easily and cost effectively incorporated into existing fast-food kitchens.

Although the invention has been shown and described above with reference to certain preferred embodiments, it will be readily appreciated by those of ordinary skill in the art that various changes and modifications may be made therein, without departing from the spirit and scope of the invention. It is intended that the claims be interpreted as including the foregoing as well as various other such changes and modifications.

What is claimed is:

1. A food preparation kitchen for preparing fast-food sandwiches comprising:
broiling means for broiling frozen sandwich products first product holding means for holding sandwich products broiled in said broiling means;
a receiving container for holding sandwich products, said receiving container operationally compatible with said broiling means and said first product holding means;
toasting means for toasting baked goods;
second product holding means for holding baked goods toasted in said toasting means;
an assembly board for assembling fast-food sandwiches from products taken from said first and second holding means; and
heat staging means for maintaining assembled fast-food sandwiches at elevated temperatures.

2. The food preparation kitchen of claim 1 wherein said broiling means automatically cooks frozen sandwich products in batches.

3. The food preparation kitchen of claim 1 wherein said broiling means further comprises a freezer compartment for storing frozen sandwich products.

4. The food preparation kitchen of claim 1 wherein said broiling means further comprises:
frozen sandwich product propositioning means for prepositioning stacks of frozen sandwich products; and
frozen sandwich product auto-loading means for loading said prepositioned sandwich products onto said broiling means.

5. The food preparation kitchen of claim 1 wherein said broiling means further comprises a cooked sandwich product discharge means for discharging broiled sandwich products from said broiling means into said receiving container for holding sandwich products.

6. The food preparation kitchen of claim 1 wherein said broiling means further comprises a self-return cooked sandwich product discharge means for returning broiled products to the same side of said broiling means from which the frozen products entered said broiling means.

7. The food preparation kitchen of claim 1 wherein the broiling means further comprises:
a compartment to store frozen sandwich products before placement in the automatic broiler;
automatic loading means for pre-staging said raw sandwich products;
cooking means that retrieves the raw sandwich products from the automatic loading means, cooks the raw sandwich products and discharges the now cooked sandwich products from the cooking device on the same side of the cooking device as the automatic loading means; and
a discharge receiving container to catch and hold the cooked sandwich product after discharge from the cooking means.

8. The food preparation kitchen of claim 1 wherein said first product holding means further comprises:
a housing;
a plurality of heating compartments in said housing wherein said plurality of compartments of said housing are of a predetermined shape to receive said receiving container; and
a heat source for heating articles placed in said housing.

9. The food preparation kitchen of claim 8 wherein said heat source heats each of said plurality of heating compartments.

10. The food preparation kitchen of claim 8 wherein said heat source heats individual compartments in said plurality of heating compartments.

11. The food preparation kitchen of claim 8 further comprising a product quality timer for indicating which food product in the plurality of compartments should be used first.

12. The food preparation kitchen of claim 1 wherein said first product holding means further comprises:
a housing;
a plurality of heating compartments in said housing of a predetermined shape to receive said receiving containers;
a heat source for providing heat to food products in said receiving containers in said compartments; and
a product quality timer.

13. The food preparation kitchen of claim 1 wherein said toasting means further comprises a baked goods toasting means.

14. The food preparation kitchen of claim 1 wherein said toasting means further comprises a vertical toasting means.

15. The food preparation kitchen of claim 1 wherein said toasting means is located on a movable cart, said movable cart further comprising a means for storing untoasted baked goods.

16. The food preparation kitchen of claim 1 wherein said second product holding means comprises:
a housing with an interior;
a plurality of insert trays for holding said toasted baked goods wherein said plurality of insert trays are of a predetermined shape for placement in said housing; and
a steam source for heating said toasted baked good articles placed in said plurality of insert trays in said housing.

17. The food preparation kitchen of claim 16 wherein said insert trays further comprise:
an inwardly sloped front end;
a substantially vertical back end; and
a rounded mid-section wherein said rounded mid-section is slotted to allow fluid communication between said baked goods in said insert tray and the interior environment of said housing.

18. The food preparation kitchen of claim 16 further comprising a product quality timer for indicating which toasted baked good in said insert tray should be used first.

19. The food preparation kitchen of claim 1 wherein said assembly board is proximate to said first product holding means and said second product holding means.

20. The food preparation kitchen of claim 1 wherein said assembly board further comprises a plurality of recessed ingredient-holding bins, for holding fast-food sandwich ingredients.

21. A food preparation kitchen for preparing fast-food sandwiches comprising:
broiling means for broiling frozen sandwich products;
first product holding means for holding sandwich products from said broiling means;
a receiving container for holding sandwich products wherein said receiving container is operationally compatible with said broiling means and said first product holding means;
toasting means for toasting baked goods;
second product holding means for holding toasted baked goods from said toasting means;
an assembly board for assembling fast-food sandwiches from products taken from said first and second holding means;
a steam generating assembly for increasing the temperature of products removed from said first or second holding means; and
heat staging means for maintaining sandwiches assembled at said assembly board at elevated temperatures.

22. The food preparation kitchen of claim 21 wherein said steam generating assembly further comprises:
a steam module housing including a supply source;
a steam generating heating element provided in the steam module housing;
a target area in fluid communication with said steam generating heating element over which the food product may be positioned; and
an actuation switch for initiating a steam delivery cycle wherein steam is released to said target area to heat the food product.

23. The food preparation kitchen of claim 22 wherein said target area is substantially nonconductive.

24. The food preparation kitchen of claim 22 wherein said target area has a plurality of perforations of a predetermined orientation to achieve a uniform heating of the food product or toasted baked good placed on the target area.

25. The food preparation kitchen of claim 22 wherein said perforations are arranged in substantially a pair of concentric circles.

26. The food preparation kitchen of claim 24 wherein low pressure steam is delivered through said perforations.

27. The food preparation kitchen of claim 24 wherein steam is generated in situ proximate said target area by said steam generating heating element.

28. The food preparation kitchen of claim 22 wherein said steam generating heating element steams approximately 3 to 8 grams of water per cycle.

29. The food preparation kitchen of claim 22 wherein said steam generating heating element steams approximately 4.5 grams of water per cycle.

30. The food preparation kitchen of claim 22 wherein the temperature of said steam generating heating element is within the range of between approximately 280° F. to 360° F.

31. The food preparation kitchen of claim 22 wherein steam generation at said steam generator is completed within the range of between approximately 3 seconds and 10 seconds.

32. The food preparation kitchen of claim 22 and further comprising a steam cycle switch for adjustably controlling the time to complete each steam generating cycle.

33. The food preparation kitchen of claim 22 and further comprising a steam cycle switch for adjustably controlling the amount of steam generated by said steam generating heating element.

34. The food preparation kitchen of claim 22 wherein said steam module housing is configurably mountable to said assembly board in an assembly line of a fast-food restaurant.

35. The food preparation kitchen of claim 34 wherein said steam module housing is notched for mounting to said assembly board.

36. The food preparation kitchen of claim 22 and further comprising a water supply and water regulator fluidly connected to said steam generating heating element.

37. The food preparation kitchen of claim 22 and further comprising an outlet to spray water over said steam generating heating element.

38. The food preparation kitchen of claim 22 wherein said water regulator is fluidly connected to two or more steam generating heating elements.

39. The food preparation kitchen of claim 22 and further comprising: a product adapter housing configured to receive said receiving trays and removably mountable to said steam module housing, said product adapter housing further comprising;
a substantially horizontal bottom plate having at least one target area cutout for receiving said target area to allow the passage of steam from said target area into said compartment; and
a conductive heat plate positioned at the bottom of said compartment above said substantially horizontal bottom plate.

40. The food preparation kitchen of claim 21 wherein said steam generating assembly further comprises:
a steam module housing comprising:
a first steam generating heating element; and
a first target area in fluid communication with said first steam generating heating element over which the food product or toasted baked good may be positioned; and
a second steam generating heating element, and
a second target area in fluid communication with said second steam generating heating element over which the food product or toasted baked good may be positioned; and
actuation means for initiating a steam delivery cycle to at least one of said first or said second target areas so as to heat the food product positioned over said first or said second target areas.

41. The food preparation kitchen of claim 40 wherein said actuation means initiates a steam delivery cycle to both said first and said second target areas simultaneously.

42. The food preparation kitchen of claim 40 wherein at least one of said first or said second target areas is substantially nonconductive.

43. The food preparation kitchen of claim 43 wherein at least one of said first or said second target areas has a plurality of perforations of a predetermined orientation to achieve uniform cooking of the food products and toasted baked goods placed on the target area.

44. The food preparation kitchen of claim 43 wherein low pressure steam is delivered through said perforations.

45. The food preparation kitchen of claim 40 wherein steam is generated in situ proximate said first or said second target areas by at least one of said first or said second steam generating heating elements.

46. The food preparation kitchen of claim 40 wherein at least one of said first or said second steam generating heating elements steams approximately 3 to 8 grams of water per cycle.

47. The food preparation kitchen of claim 40 wherein at least one of said first or said second steam generating heating elements steams approximately 4.5 grams of water per cycle.

48. The food preparation kitchen of claim 40 wherein the temperature of at least one of said first or said second steam generating heating elements is within the range of between approximately 280° F. and 360° F.

49. The food preparation kitchen of claim 40 wherein steam generation at said steam generator is completed within the range of between approximately 3 seconds to 10 seconds.

50. The food preparation kitchen of claim 40 and further comprising a steam cycle switch for adjustably controlling the time required to complete each steam generating cycle.

51. The food preparation kitchen of claim 40 further comprising a steam cycle switch for adjustably controlling the amount of steam generated at steam generating element.

52. The food preparation kitchen of claim 40 wherein said steam module housing is configurably mountable to said assembly board in the assembly line of a fast-food restaurant.

53. The food preparation kitchen of claim 40 further comprising:
a tray receiving compartment configured to accept said food product receiving compartments and capable of attaching to said steam module housing, said tray receiving compartment further comprising;
a substantially horizontal bottom plate arranged to allow the passage of steam from said first perforated target area and said second perforated target area into said compartment; and
a conductive heat plate positioned at the bottom of said compartment above said substantially horizontal bottom plate.

54. The food preparation kitchen combination in claim 21 wherein said heat-staging means is proximate to said assembly board and accessible to personnel at the distal end of said heat staging means.

55. The food preparation kitchen in claim 21 wherein said heat staging means further comprises means for storing assembled and packaged fast-food sandwiches at temperatures above ambient conditions.

56. The food preparation kitchen in claim 21 wherein said heat staging means further comprises means for storing assembled and packaged fast-food sandwiches at a minimum of 100° F. for minimum of ten minutes.

57. A food preparation kitchen for preparing fast-food sandwiches comprising:
an automatic, self-return broiler comprising:
a freezer compartment to store frozen sandwich products before placement in the automatic broiler;
an automatic loading mechanism for pre-staging said raw sandwich products;
cooking means that retrieves the frozen sandwich products from the automatic loading mechanism, cooks the frozen sandwich products and discharges the now cooked sandwich products from the cooking means on the same side of the cooking means as the automatic loading mechanism; and
a sandwich product receiving pan to catch and hold the cooked sandwich product after discharge from the cooking means;
a sandwich product holding cabinet for receiving and storing said cooked sandwich products comprising;
a first housing,
a plurality of compartments in said first housing configured to receive said sandwich product receiving pan;
a heat source for providing heat to the sandwich products in said sandwich product receiving pans in said compartments;
a product quality timer for indicating which sandwich product in the plurality of compartments should be used first;
a bread product toasting assembly proximate to said automatic broiler wherein said bread product toasting assembly is movable;
a toasted bread product holding cabinet for storing toasted bread products proximate to said bread product toasting assembly, said toasted bread product holding cabinet further comprising;
a second housing with an interior portion;
a steam source;
a plurality of insert trays to receive toasted bread products and configured with a plurality of open notches providing fluid communication between the interior of the second housing and the toasted bread products held in the insert trays; and
a product quality timer for indicating which insert tray holds the toasted bread products to be used first;
an assembly board proximate to said sandwich product holding cabinet and toasted bread product holding cabinet, said assembly board for preparing fast-food sandwiches thereon and wherein said assembly board includes a plurality of recessed ingredient bins for holding sandwich ingredients;
a steam generating assembly to increase the temperature of food products taken from said second food holding cabinet; and
a heat staging apparatus to store finished products at a temperature above ambient conditions whereby such heat staging apparatus is located proximate to said assembly station and accessible to personnel at a distal end of said heat staging apparatus.

58. A method for preparing fast-food sandwiches comprising:
broiling a first food product;
placing the broiled first food product in a food product receiving tray;
holding the broiled first food product in said food product receiving tray at temperatures above ambient kitchen temperatures;
toasting a second food product;
holding the toasted second food product at temperatures above ambient kitchen temperatures;
increasing the temperature of said second food product above the temperature at which said second food product had been held;
assembling said first and second food products with other sandwich products and ingredients removed from holding bins at an assembly board; and
storing fully assembled sandwiches at temperatures above ambient kitchen temperatures.

59. The method of claim 58 and further comprising storing frozen sandwich products proximally to the broiling apparatus.

60. The method of claim 58 wherein said broiling step includes the step of automatically cooking frozen sandwich products as a batch.

61. The method of claim 58 wherein broiling step further comprises the steps of:
prepositioning a raw sandwich product; and
auto-loading a raw sandwich product into the broiling apparatus.

62. The method of claim 58 wherein said broiling step includes the step of discharging cooked sandwich products from the broiling apparatus.

63. The method of claim 58 wherein said broiling step includes the step of discharging cooked sandwich products from the broiling apparatus on the same working side of the broiling apparatus as the side of prepositioning and auto-loading of the raw sandwich products.

64. The method of claims 58 wherein said cooked sandwich products are discharged into a receiving pan.

65. The method of claim 58 wherein said broiling step further comprises the step of:
storing frozen first food products proximally to the broiling apparatus before placing the frozen first food products in the broiling apparatus;
automatically loading and pre-staging said frozen first food products in the broiling apparatus;
retrieving the frozen first food products from the automatic loading mechanism;
automatically cooking the frozen first food products and discharging the now cooked first food products from the cooking device on the same side of the cooking device as the automatic loading mechanism; and
discharging said cooked first food products into a receiving tray.

66. The method of claim 58 wherein the step of holding broiled first food products in said food product receiving tray includes holding said food product receiving pans in a first housing.

67. The method of claim 66 wherein said housing comprises:
a plurality of compartments configured to receive said food product receiving trays; and
a heat source.

68. The method of claim 67 wherein said heat source heats individual tray receiving compartments of plurality of tray receiving compartments.

69. The method of claim 67 wherein said housing further comprising a product quality timer associated with each tray receiving compartment indicating the product quality of the food products in each food product receiving tray.

70. The method of claim 58 wherein said toasting step comprises toasting bread products.

71. The method of claim 58 wherein said toasting step further comprises toasting bread products in a vertical toasting apparatus as a batch.

72. The method of claim 58 wherein said toasting step includes storing untoasted bread products proximal to said toasting apparatus.

73. The method of claim 58 wherein the step of holding a toasted second food product includes holding said toasted second food product in a second housing with an interior portion.

74. The method of claim 73 wherein said housing further comprises:
a steam source;
a plurality of inserts for holding toasted second food products, said inserts further comprising;
an inwardly sloping front end;
a substantially vertical back end; and
a rounded mid-section wherein said rounded mid-section is slotted to provide fluid communication between the toasted second food products held in said insert and the interior environment of the housing; and
a product quality timer associated with each insert indicating the product quality of the food products in each insert.

75. The method of claim 58 and further comprising performing said assembling step proximally to said first housing of said broiled first food product holding step and said second housing of said toasted second food product holding step and on a substantially horizontal assembly board.

76. The method of claim 75 wherein said assembly board further comprises a plurality of recessed ingredient bins for holding sandwich ingredients.

77. The method of claim 58 wherein said raising step further comprises the steps of:
placing at least a portion of a toasted second food product on a target area;
actuating a steam delivery cycle;
flashing a predetermined quantity of water to generate and release steam through said target area and into at least a portion of a toasted second food product; and
removing the toasted second food product from said perforated target area.

78. The method of claim 77 wherein said target area is substantially nonconductive.

79. The method of claim 77 wherein said target area has a plurality of perforations for uniformly heating said food product.

80. The method of claim 77 and further comprising delivering low pressure steam through said perforations.

81. The method of claim 77 wherein said flashing of water occurs in situ proximate said target area.

82. The of claim 77 wherein said predetermined quantity of water is approximately 3 to 8 grams per steam delivery cycle.

83. The method of claim 77 wherein said flashing of water occurs within a temperature range of between approximately 280° F. to 360° F.

84. The method of claim 77 wherein the time of said steam delivery cycle is within the range of between approximately 3 seconds to 10 seconds.

85. An assembly method for preparing multi-ingredient, heated, fast-food sandwiches by employees working at assembly stations proximate to and on opposite sides of a steam generating assembly placed on an assembly board of a fast-food restaurant comprising:
providing batches of sandwich ingredients at the sandwich assembly stations;
steaming at least one heated ingredient of a first sandwich and at least one heated ingredient of a second sandwich on said steam generating assembly, wherein said heated ingredients of said first and said second sandwiches are placed on the steam generating assembly by a first employee who actuates the steam generating assembly;
pre-assembling the remaining ingredients of said first sandwich at one assembly station while said at least one heated ingredient of said first sandwich is being steamed, wherein said pre-assembly is carried out by the first employee;
pre-assembling the remaining ingredients of said second sandwich at another assembly station while said at least one heated ingredient of said second sandwich is being steamed, wherein said pre-assembly is performed by a second employee;
removing said at least one heated ingredient of said first sandwich from the steam generating assembly and assembling a first sandwich by placing said at least one heated ingredient of said first sandwich with said pre-assembled ingredients of said first sandwich, wherein said removal and assembly is performed by the first employee;
removing said at least one heated ingredient of said second sandwich from the steam generating assembly and assembling a second sandwich by placing said at least one heated ingredient of said second sandwich with said pre-assembled ingredients of said second sandwich, wherein said removal and assembly is performed by the second employee;
wrapping a fully-assembled first sandwich, wherein said first sandwich is wrapped by the first employee;
wrapping a fully-assembled second sandwich, wherein said second sandwich is wrapped by the second employee; and
moving said wrapped fully-assembled said first and second sandwiches to a holding station, wherein said first and second sandwiches are moved by the second employee.

86. The method of claim 85 wherein each assembly station contains sandwich ingredients and wrappers that an employee at an assembly station can use to assemble and wrap a sandwich without obtaining ingredients from another assembly station.

87. The method of claim 85 wherein said moving step further comprises moving said first and second wrapped and fully-assembled sandwiches to a heated holding station.

88. The method of claim 58 and further comprising performing said assembling step is at an assembly station proximate to said first and second food product holding units such that a second employee at said assembly station can access said first and second product holding units without interfering with said first employee, said assembly station further comprising:
a plurality of condiment and garnish trays; and
a bread product re-heater.

89. The method in claim 58 wherein said storing step is performed by heat staging means proximate to said assembly station and accessible to employees at the distal end of said heat staging means.

90. The method in claim 58 wherein said storing step is performed by heat staging means, said heat staging means further comprising means for storing assembled and packaged fast-food sandwiches at temperatures above ambient conditions.

91. The method in claim 57 wherein said heat staging means further comprises means for storing assembled and packaged fast-food sandwiches at a minimum temperature of approximately 100° F. for a minimum time of approximately 10 minutes.
